(19) United States
(12) Patent Application Publication
(10) Pub. No.: US 2011/0006619 A1
(43) Pub. Date: Jan. 13, 2011

(54) IMPACT GENERATOR AND IMPACT TESTING PLATFORM

(76) Inventor: Kun-Ta LEE, Shen Ken Hsiang (TW)

Correspondence Address: Muncy, Geissler, Olds & Lowe, PLLC, 4000 Legato Road, Suite 310, FAIRFAX, VA, 22033, US

(21) Appl. No.: 12/621,987

(22) Filed: Nov. 19, 2009

(30) Foreign Application Priority Data
Jul. 8, 2009 (TW) 098212408

(51) Int. Cl. H02K 33/02

(52) U.S. Cl. 310/30; 73/12.04

(57) ABSTRACT

An impact generator and an impact testing platform applying the impact generator are provided. The impact generator comprises a magnetic device, a coil, and an elastic device. The coil has a first receiving space for receiving the magnetic device, and the elastic device biases the magnetic device to an initial position. While a current is directed into the coil, a magnetic field is induced in the first receiving space to actuate the magnetic device to generate an impact to the ambience. While the current is blocked, the magnetic device returns to the initial position via the elastic device.

This application claims priority to Taiwan Utility Model Application No. 098212408 filed on Jul. 8, 2009, the disclosures of which are incorporated herein by reference in their entirety.

### CROSS-REFERENCES TO RELATED APPLICATIONS

Not applicable.

### BACKGROUND OF THE INVENTION

1. Field of the Invention

The present invention provides an impact generating device, in particular, to an electromagnetic impact generating device.

2. Descriptions of the Related Art

With the advancement of technologies, there are many new and updated products on sales in the market. To provide consumer reliable products in the competitive market, every manufacturer consistently strives to improve their products reliability to attract consumers. Impact testing platforms are frequently used by the product manufacturers to test the impact resistance and longevity of the products. Conventional impact testing platforms employ at least an air hammer to produce an impact force of random magnitude and frequency to test the impact resistance of a to-be tested product mounted on the impact testing platforms. However, due to the characteristics of the air hammer, the impact of random magnitude and frequency could not be determined; as a result, manufacturers could not precisely determine the impact resistance of the to-be tested product to the impact of specific impact form, magnitude and frequency.

In view of this, it is highly desirable in the art to provide an impact generator which can produce an impact force of specific magnitude and frequency.

### SUMMARY OF THE INVENTION

The primary objective of this invention is to provide an impact generator, which is capable of generating an impact of specific magnitude and frequency.

The impact generator comprises a magnetic device, a coil and an elastic device. The coil has a first receiving space for receiving the magnetic device which is biased by the elastic device to an initial position. The coil is adapted to induce a magnetic field in the first receiving space when a current is directed to the coil, such that the magnetic device is actuated by the magnetic field generated by the coil to produce an impact to the ambience. The magnetic device is adapted to return to its initial position by the elastic device when the current is blocked.

The magnitude and frequency of the impact of the generator are further controlled by controlling the current directed to the coil such that product manufacturers can precisely test the impact resistance of a to-be tested product with respect to the impact of specific magnitude and frequency.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a section view of an impact generator of a first preferred embodiment in accordance with the present invention;

FIG. 2 is a section view of a impact generator of a second preferred embodiment in accordance with the present invention; and

FIG. 3 is a perspective view of an impact testing platform in accordance with the present invention.

### DESCRIPTION OF THE PREFERRED EMBODIMENT

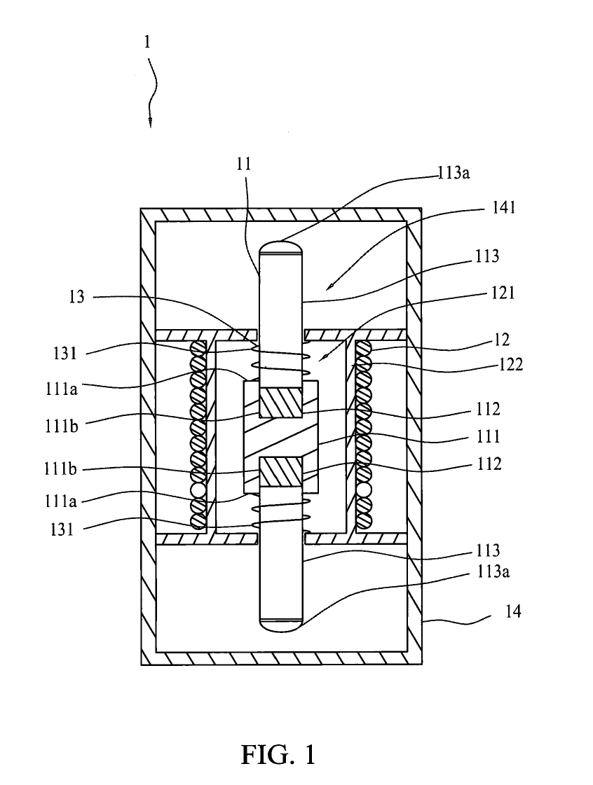

FIG. 1 illustrates the impact generator of the first preferred embodiment of the present invention, which comprises a magnetic device 11, a coil 12 and an elastic device 13. The coil 12 is provided with a first receiving space 121 for receiving the magnetic device 11. The elastic device 13 biases the magnetic device 11 to an initial position. A magnetic field is induced in the first receiving space 121 while a current is directed into the coil 12. The magnetic device 11 is adapted to be actuated by the magnetic field generated by the coil 12 to generate an impact to the ambience while the current is directed into the coil 12. The magnetic device 11 returns to the initial position by the use of the elastic device 13 while the current is blocked. The current directed to the coil 12 can be DC, AC or other forms of pulse current, which are capable of actuating the impact generator 1 to generate an impact force to the ambience.

The magnetic device 11 comprises at least a magnetic element 112 and a columnar main body 111. The main body 111 is contained within a tube body 122 of the coil 12. The magnetic element 112 is mounted at least on one end 111a of the main body 111. The end of the main body 111 has a depression 111b adapted to receive the magnetic element 112. Preferably, the main body 111 has two ends 111a, and two depressions 111b that are respectively disposed at the ends 111a, and two magnetic elements 112 that are respectively disposed in both depressions 111b of the two ends 111a respectively to enhance the magnetic force of the magnetic device 11.

Furthermore, the magnetic device 11 of the present invention comprises an impacting element 113 for assisting the magnetic device 11 to generate an impact to the ambience. The impacting element 113 is disposed at the end 111a of the main body 111. Preferably, the magnetic device 11 comprises two impacting elements 113 respectively disposed at the ends 111a of the main body 111. Each of the impacting elements 113 of the impact generator 1 can further comprises a cushion body 113a which is made of an elastic material. As shown in FIG. 1, the cushion bodies 113a are disposed at the impaction end of the impacting elements 113. Thus, under constant and repetitive impact, the impact generator 1 is prevented from damaging by the magnetic device 11, and the longevity of the impact generator 1 is prolonged.

The magnetic coil 12 comprises a tube 122 adapted to define the first receiving space 121. The wire winds the external side of the tube 122, while the magnetic device 11 is contained at the inner side of the tube 122. The elastic device 13 comprises at least an elastic element 131 which is fastened to the magnetic device 11. In the preferred embodiment, the elastic device 13 should comprise two elastic elements 131 respectively disposed at the ends 111a of the main body 111. The corresponding opposite ends of the two elastic elements 131 are respectively fastened to the two ends of the tube 122 of the coil 12. In the preferred embodiment, the elastic element 131 is a spring that is commonly used. The impact generator 1 should further comprise a shell 14, wherein the shell 14 defines a second receiving space 141 for receiving the coil 12, the elastic device 13 and the magnetic device 11. The coil 12 is fastened at the inner side of the shell 14.

A magnetic field is generated by the coil 12 when the current is directed into the coil 12. The magnetic field repels the magnetic element 112 of the magnetic device, therefore the main body 111 is actuated to move towards the shell 14. The shell 14 is subjected to the impact of the impacting elements 113 and the cushion bodies 113a and generates an impact to the ambience. By means of the elastic elements 131 of the elastic device 13, the magnetic device 11 returns to the initial position, at which the magnetic device 11 has not yet to be moved by the magnetic field, while the current to the coil 12 is blocked. Thus, the impact generator 1 in accordance with the present invention can be controlled with respect to the impact form, frequency and magnitude of the impact force generated by the impact generator 1 depending on the needs of different situations by adjusting the form, frequency and magnitude of the current, which is directed to the coil 12.

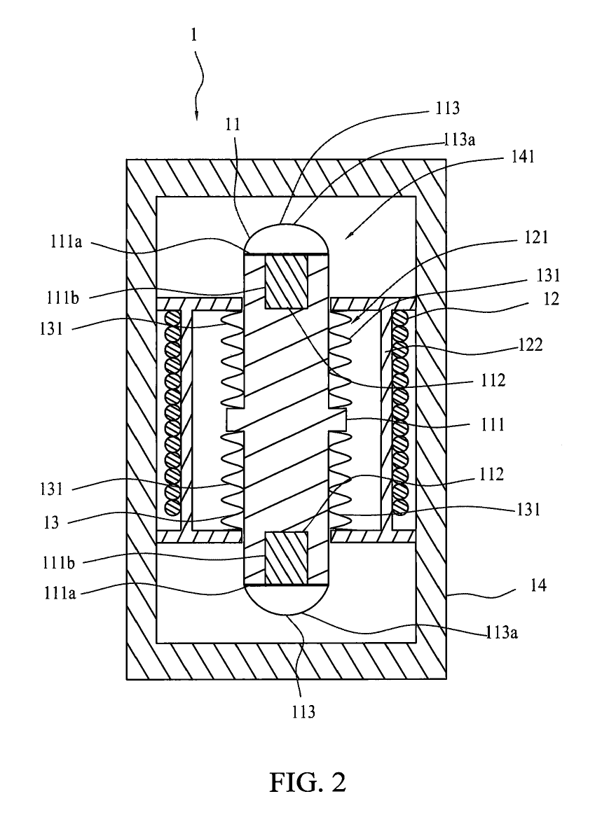

FIG. 2 illustrates the second preferred embodiment of the impact generator which is similar to that of the first preferred embodiment of the present invention. In the preferred embodiment, the elastic device 13 comprises four elastic elements 131 of which conventional springs can be used. In the preferred embodiment, one end of the individual elastic element 131 is fastened to the lateral surface of the main body 111 of the magnetic device 11, and the other end of the individual elastic element 131 is fastened to the tube 122 of the coil 12. Furthermore, in the first preferred embodiment, the impacting element 113 has a columnar body, and the cushion body 113a is disposed at one end of the columnar body, as shown in FIG. 1. However, in this preferred embodiment, no columnar body is provided, and the cushion bodies 113a are directly disposed at the two ends of the main body 111 of the magnetic device 11. Other components of the second preferred embodiment are the same as that of the first preferred embodiment; redundant descriptions will be omitted as required for the sake of clarity of the description.

To those skilled in the art, the number and connection method of elastic elements 131, and the shapes of individual elements of the impact generator 1 can be easily modified. In other embodiments, the elastic elements 131 can directly dispose to the shell 14 and the magnetic device 11 instead of at the coil 12. This will cause the magnetic device 11 to restore to the initial position as well. In another preferred embodiment, the impact generator 1 may not include the shell 14 but it can directly impact an object in the ambience to effect the function of impacting. In view of above, people skilled in this field may proceed with a variety of modifications and replacements based on the disclosures and suggestions of the invention as described without departing from the characteristics thereof. Nevertheless, such modifications and replacements are not fully disclosed in the above descriptions, they have substantially been covered in the following claims as appended.

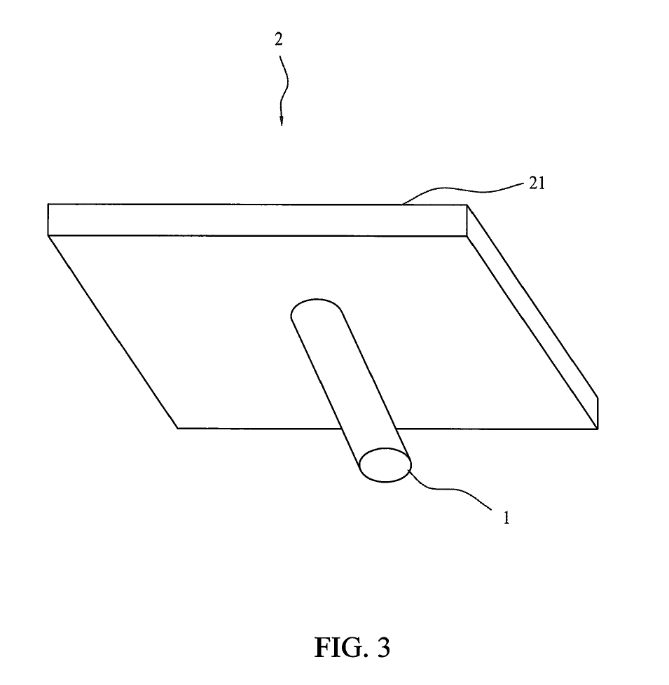

FIG. 3 illustrates the impact testing platform 2 using the impact generator 1 in accordance with the present invention. The impact testing platform 2 comprises at least an impact generator 1 and a plate 21. The impact generator 1 is disposed at one surface of the plate 21. A corresponding surface of the plate 21 is adapted to be fastened with a to-be tested object for impact testing. Thus, when the impact generator 1 generates an impact with a specific form, a specific magnitude and a specific frequency, the impact generator 1 actuates the plate 21, such that the to-be tested object fastened on the plate 21 is subjected to an impact. Thus, the impact resistance of the to-be tested object is determined.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An impact generator, comprising:
a magnetic device;
a coil having a first receiving space for receiving the magnetic device, in which a magnetic field is induced in the first receiving space while a current is directed into the coil; and
an elastic device biasing the magnetic device to an initial position;
wherein the magnetic device is adapted to be actuated by the magnetic field generated by the coil to generate an impact force to the ambience while the current is directed into the coil, and the magnetic device returns to the initial position by the use of the elastic device while the current is blocked.

2. The impact generator as claimed in claim 1, wherein the magnetic device has a columnar main body, and the coil comprises a tube for receiving the main body of the magnetic device.

3. The impact generator as claimed in claim 2, wherein the magnetic device comprises a magnetic element, the main body has an end, and the magnetic element is disposed on the end.

4. The impact generator as claimed in claim 3, wherein the magnetic device comprises two magnetic elements, the main body has two ends, and the magnetic elements are disposed on the ends respectively.

5. The impact generator as claimed in claim 3, wherein the end of the main body has a depression adapted to receive the magnetic element.

6. The impact generator as claimed in claim 2, wherein the elastic device comprises at least one elastic element fastened with the magnetic device.

7. The impact generator as claimed in claim 6, wherein the main body of the magnetic device has an end, and the at least one elastic element is fastened with the end of the magnetic device.

8. The impact generator as claimed in claim 6, wherein the main body of the magnetic device has a lateral surface, and the at least one elastic element is fastened on the lateral surface of the magnetic device.

9. The impact generator as claimed in claim 6, wherein the at least one elastic element is a spring.

10. The impact generator as claimed in claim 2, wherein the coil has two ends, and the elastic device is fastened on at least one of the ends.

11. The impact generator as claimed in claim 1, wherein the impact generator further comprises a shell, the shell defines a second receiving space for receiving the coil, the elastic device and the magnetic device, and the coil is fastened with the shell.

12. The impact generator as claimed in claim 2, wherein the magnetic device comprises an impacting element, the main body has an end, and the impacting element is disposed on the end.

13. The impact generator as claimed in claim 12, wherein the magnetic device comprises two impacting elements, and the main body has two ends, the impacting elements are disposed on the ends respectively.

14. The impact generator as claimed in claim 12, wherein each of the impacting elements comprises a cushion body.

15. An impact testing platform, comprising:
an impact generator as claimed in claim 1; and
a plate fastened with the impact generator.
